(19) United States
(12) Patent Application Publication
(10) Pub. No.: US 2025/0330073 A1
(43) Pub. Date: Oct. 23, 2025

(54) Radial flux double-rotor machine

(71) Applicant: DeepDrive GmbH, Garching (DE)

(72) Inventors: Alexander ROSEN, Osnabrück (DE); Markus DOMME, München (DE)

(21) Appl. No.: 18/873,084

(22) PCT Filed: Jun. 5, 2023
(86) PCT No.: PCT/EP2023/064926

§ 371 Date: Dec. 9, 2024

(30) Foreign Application Priority Data
Jun. 10, 2022 (DE) 102022205930.1

(51) Int. Cl. H02K 16/02

(52) U.S. Cl. CPC H02K 16/02

(57) ABSTRACT

The present disclosure relates to a radial flux double-rotor machine, including a stator which has a stator core and a torsionally stiff winding received therein, in which in a radially inner part of the stator the conductor bars of the torsionally stiff winding extend helically in a first direction of rotation, and in a radially outer part of the stator the conductor bars of the torsionally stiff winding extend helically in an opposite second direction of rotation.

### FIELD OF THE INVENTION

The present invention relates to a radial flux double-rotor machine, in particular for a wheel hub drive.

### BACKGROUND

Electric machines having a stator and two rotors which are connected together for conjoint rotation, so-called double-rotor machines (in addition to double-rotor, also referred to as multi-rotor, dual-rotor etc.) can increase both the torque density and the efficiency of electric drives compared with conventional electric machines having only one rotor. This can be attributed to the fact that, particularly in the so-called “yokeless” design, no back iron is required in the stator and, as a result, the magnetic losses can be significantly reduced. In addition, with two rotors there is basically more space available for the field-exciting magnets (in the case of permanent magnet-excited synchronous machines, PSM) or the conductor material (in the case of induction machines, IM or electrically excited synchronous machines, ESM). According to the orientation of the magnetic field lines in the air gap, such machines can be divided into two groups, axial flux-carrying (field lines in parallel with the axis of rotation, so-called axial flux machines) on the one hand and radial flux-carrying (field lines in a radial direction in the air gap, so-called radial flux machines) on the other hand.

Axial flux double-rotor machines are described e.g. in DE 10 2015 226 105 A1 and DE 10 2013 206 593 A1. They are characterised by a high torque and power density, but are costly to manufacture because very complex geometries are punched or manufactured using powder metallurgy in the stator core. To date, such machines have therefore not made the leap into large-scale production and are used only in niche areas with high power density requirements, such as racing, aviation, etc. In addition, the mechanical fastening concepts for the stator winding permit only the use of single-tooth windings which have corresponding disadvantages in relation to noise excitations.

In contrast, in the case of radial flux double-rotor machines, manufacturing methods can be used which are established in principle for the winding and laminated core and are suitable for large-scale production. However, in this case there is a significant and largely unresolved technical challenge in terms of supporting the torque produced in the stator core. By reason of the internally and externally rotating parts, the laminated stator core cannot be mounted (e.g. pressed-in, screwed or adhered) in a fixed housing, as is otherwise usually the case. Therefore, the torque is guided to the axial ends of the laminated stator core or stator winding and is supported at this location. In the prior art, various approaches have been proposed in this regard but all are associated with considerable disadvantages in relation to function and/or costs.

EP 1 879 283 B1 describes one way of designing the stator winding as a so-called yoke winding. The annular laminated stator core has in this case grooves on the inner and outer diameter, between which there is located a back iron (also referred to as a stator yoke) which is effective in a tangential direction. In this case, forward and return conductors of each winding strand are guided in grooves lying radially one above the other in each case and are wound around the yoke. The stator yoke is axially accessible between the winding strands and can be fixed on the housing e.g. by means of axial screw-connections (described e.g. in JP 2018 082 600). The axial compression of the screws ensures both the torsion stiffness of the laminated core and torque support at the axial end. The north pole and south pole of the rotor field are located opposite one another. A disadvantage of this concept is that the magnetic flux are carried completely via the return yoke located between the stator grooves. On the one hand, this leads to an increased weight of the laminated stator core and increases the iron losses significantly. The magnetic field lines of both rotor fluxes are closed via the back iron in the laminated stator core and give rise to iron losses at this location. In addition, all individual coils of the yoke winding are interconnected in parallel or in series in the region of the winding head, which in turn leads to a conflict over installation space with torque support. However, the winding wound around the yoke allows direct mechanical contacting of the laminated stator core.

A considerable weight and loss saving can be achieved if the magnetisation directions of the magnets lying radially one above the other point in the same direction and the current supply directions of the conductors lying one above the other in the grooves are identical. In this case, the back iron in the stator can be omitted and a so-called “yokeless” double rotor machine having a distributed winding is produced. The magnetic field lines are closed over the rotor. A back iron in the stator is not required, as a result of which weight and iron losses in such machines are very low. However, the distributed winding does not permit direct mechanical contacting of the laminated stator core for torque support. For example, WO 2004/004098 A1 describes a yokeless embodiment having a distributed winding.

With respect to the axial support, various auxiliary constructions for torque support are proposed in the prior art, e.g. as described in DE 10 2010 055 030 A1 or U.S. Pat. No. 7,557,486 B2. The problem here is that electrically and/or magnetically conductive metals are not allowed to protrude into the flux-carrying region, or are allowed to do so only to a very limited extent, which severely restricts the material selection and geometric design. In contrast, synthetic material components, adhesives and/or casting materials can also be used in the flux-carrying region.

However, with such materials it is very difficult to meet the stringent requirements with regard to temperature stability and mechanical strength.

### SUMMARY OF THE INVENTION

One of the ideas of the present invention is to provide an improved radial flux double-rotor machine.

Accordingly, the following is provided:
a radial flux double-rotor machine, in particular for a wheel hub drive, comprising a stator which has a stator core and a torsionally stiff winding received therein, wherein in a radially inner part of the stator the conductor bars of the torsionally stiff winding extend helically in a first direction of rotation, and in a radially outer part of the stator the conductor bars of the torsionally stiff winding extend helically in an opposite second direction of rotation; comprising a double rotor which has an inner rotor and an outer rotor, wherein the inner rotor and the outer rotor each have an annular main body which is designed for carrying flux, and a common centre axis, wherein a plurality of permanent magnets are fastened in each case to the annular main body and each permanent magnet is allocated in the cross-section a predetermined angle segment of the annular main body, wherein the permanent magnets are formed and arranged on the respective main body such that the angle segment is displaced in the axial progression in the circumferential direction so that the permanent magnets generate a field which extends obliquely with respect to the centre axis, wherein a field of the inner rotor extends obliquely in a first direction which is oriented to the first direction of rotation, and wherein a field of the outer rotor extends obliquely in a second direction which is oriented to the second direction of rotation.

A finding forming the basis of the present invention resides in the fact that, in the case of radial flux double-rotor machines, field distortions can exist by reason of changes in the magnetic field in an axial direction. The magnetic field has the full amplitude merely in the axial centre of the machine. The axial ends of the machine experience a weakened amplitude of the magnetic field.

A further finding forming the basis of the invention resides in the fact that the field distortion leads to a displacement of the field maximum and as a result a reduction in the torque occurs.

The idea forming the basis of the present invention is to provide a combination of a specific electric synchronous machine comprising a double rotor, of which the stator has a stator core and a torsionally stiff winding, which is received therein, for torque support, and an arrangement of permanent magnets, which are displaced in the axial progression in the circumferential direction, in the respective rotors for generating an obliquely extending magnetic field.

The individual conductor bars of the torsionally stiff winding are arranged in an axial direction along a helical line of the stator grooves and a first and second direction of rotation corresponding to the radially inner and radially outer stator grooves and are connected at the conductor ends. For example, an integrally bonded connection by welding or soldering is provided for this purpose. However, other connection techniques would also be feasible. For example, two conductor bars are each connected at the conductor bar ends and all conductor bars together form such a bar structure. The winding is thus formed from conductor bars which are connected together, in particular in the manner of a bar structure. The bar structure formed with the conductor bars is for example configured in a torsionally stiff manner per se and is designed for transmitting torque about the centre axis of the stator. Therefore, the winding acquires on the one hand its torsional stiffness and in addition is connected to the stator core in a form-fitting manner for torque support.

Furthermore, the conductor bars are designed having a thickness sufficient for the transmission of power. In the case of a wheel hub motor, the thickness of the conductor bars can be e.g. in the range of several millimetres. In particular, they can be bars having a square profile with edge lengths of several millimetres.

The selected lead angle (also setting angle) of the stator grooves or the helical lines described therewith ensures that, by connecting the conductor bars introduced, conductor loops are formed. The angle of the conductor loops in the machine, which are swept in relation to the centre axis, encloses in each case a magnetic pole of the rotors. In this manner, despite the functional integration, very simple production of the stator is made possible, which manages with very few components and comparatively simple conventional connection technology and thus also with very few manufacturing steps.

The stator designed in this manner can now be completed with inventive inner and outer rotors to form an electric machine in accordance with the invention. The torsionally stiff winding includes a division of the stator into a radially inner and outer part, wherein the conductor bars of the torsionally stiff winding of the radially inner part are arranged helically in a first direction of rotation and the conductor bars of the radially outer part are arranged helically in an opposite second direction of rotation. The resulting continuous (tangential) displacement of the conductor bars via the axial position in the electric machine causes the magnetic field generated by the torsionally stiff winding to change via the axial position in the machine. Consequently, the magnetic field has the maximum amplitude only in the axial centre of the electric machine where the conductor bars of the same strand and same current direction are positioned one above the other. By reason of underlying geometry, the amplitude of the magnetic field is reduced towards the two axial ends of the electric machine. For the resulting flux linkage and the torque of the electric machine, the average value over the entire length is of particular relevance.

In addition to the reduction in the amplitude of the magnetic field, a distortion of the magnetic field in the tangential direction is also produced at the axial ends of the electric machine by reason of the rotational displacement of the conductor bars with respect to one another, which results in a tangential displacement of the maximum of the magnetic field. With a conventional arrangement of the permanent magnets, this distortion of the magnetic field would result in a reduction in the torque because the permanent magnets in the rotors are no longer in the position which is optimal in each case for torque generation.

Therefore, in accordance with the invention the torque reduction by reason of the distortion of the magnetic field is counteracted by means of a novel arrangement of the permanent magnets. For this purpose, the permanent magnets of the respective rotors are displaced in the axial progression in the circumferential direction in order thereby to generate obliquely extending magnetic fields. The generated oppositely obliquely extending fields of the inner rotor and outer rotor extend in two oblique directions which correspond to the respective corresponding and mutually opposite rotational directions of rotation of the conductor bars of the torsionally stiff winding. For example, the inventive axial displacement of the permanent magnets in the circumferential direction has a positive effect on the generated torque and, in particular, enables a torque increase of up to 10% compared to a non-inclined arrangement of the permanent magnets in the inner and outer rotors.

The rotors are produced for example from soft-magnetic solid material and with surface-mounted permanent magnets. The small upper field spectrum of the winding variants described in this case and the distance between the solid material and the air gap ensured by the magnets prevent the occurrence of unacceptably large losses by reason of eddy currents in the rotors. In this design, comparatively high degrees of efficiency can then be achieved for example and the rotors can still be manufactured in a very cost-effective manner.

A support device of the stator which is in engagement in particular with the torsionally stiff winding is fixedly connected by means of a suitable method to the base as the stationary part of the electric machine. One possible embodiment provides for this purpose cut-outs, e.g. through-bores, for force-fitting fastening means, such as e.g. screws. However, in addition or alternatively it would of course also be feasible to use form-fitting connecting means and/or an integrally bonded connection.

In particular, the present invention can be used for example for a wheel hub motor, for example for a motor vehicle. The construction in accordance with the invention ensures that, by reason of the functional integration, the mass of a radial flux double-rotor machine can be reduced and the torque density can be increased, which advantageously means a reduction in unsprung masses, particularly in the case of wheel hub motors. Furthermore, in accordance with the invention a comparatively short axial length can be achieved with a comparatively large diameter, which is particularly advantageous in the wheel interior in relation to torque support and installation space.

On the other hand, in accordance with the invention, in spite of the extremely compact design very high torques are also possible, in particular they are high enough in order to drive a wheel of a vehicle directly without a transmission. Thus, in a particularly advantageous manner transmission losses are avoided, further weight is saved and particularly high advantages in terms of the degree of efficiency can be achieved.

Furthermore, this high torque which, for installation sizes within the dimensions of standard motor vehicle rims, is already clearly possible in the four-digit range, in particular greater than 1000 Nm, for example greater than 1500 Nm, particularly for example greater than 5000 Nm, and thus already extends into the range of the limit of liability of standard road tyres, even allows a rear axle wheel brake to be replaced by the wheel hub motor. Therefore, in the application as a wheel hub motor particular synergies or functional integrations are made possible.

Advantageous embodiments and developments are apparent from the further dependent claims and from the description with reference to the figures of the drawing.

According to some embodiments, the annular main body is manufactured from solid material. The torsionally stiff winding offers for the first time the possibility of designing the winding of a synchronous machine with a double rotor, as a distributed winding with a correspondingly small upper field spectrum. Only in this embodiment can the rotors be manufactured from solid material because only small upper fields and resulting eddy currents are generated in the rotor by the winding. Accordingly, in the manufacture of the inner and outer rotors consisting of soft-magnetic solid material costs can be saved by reason of the simplified manufacture and a high level of efficiency can be achieved.

According to a further embodiment, the permanent magnets are arranged at a predetermined helix angle relative to the axial direction of the centre axis on the annular main body. This makes it possible to orient the magnetic field, which is generated by the permanent magnets, in a targeted manner relative to the centre axis of the annular main body and thus to generate the desired oblique magnetic field. The helix angle can be freely adjusted because it is influenced substantially by the actual positioning and/or orientation of the permanent magnets. In this manner, it is advantageously possible to counteract a torque reduction by reason of a field distortion by means of the targeted adjustment of the predetermined helix angle.

According to a further embodiment, the permanent magnets are each divided into a plurality of axial segments. Each axial segment is allocated an angle segment which is displaced with respect to an adjacent axial segment by a setting angle about the centre axis. A resulting total helix angle about the centre axis or in the circumferential direction is determined from the setting angle, in particular from a multiple of the setting angle. Furthermore, the axial segments can be oriented with an edge in parallel with the centre axis of the annular main body. The number of the axial segments and the setting angle of the individual axial segments with respect to one another are freely selectable. In this manner, a radial flux double-rotor machine is provided which can be configured in relation to manufacturing costs and field optimisation.

According to a further embodiment, in the case of a predetermined number of n axial segments per permanent magnet the resulting total helix angle ϕ is determined from the setting angle θ with the relation, ϕ=n*θ. By reason of the mathematically simple relationship between the number of axial segments per permanent magnet and the setting angle, the individual parameters of the magnet arrangement of the rotor of a radial flux double-rotor machine in accordance with the invention can be calculated in a simple way and easily implemented. Therefore, the radial flux double-rotor machine can be easily adapted or correspondingly designed for different requirements.

According to a further embodiment, the permanent magnets are each divided into two axial segments. In this manner, a variant of the radial flux double-rotor machine in accordance with the invention is provided which is simple to manufacture and therefore is particularly advantageous in relation to the production costs. By reason of the still low number of axial segments, the orientation and assembly of the segments remain comparatively simple but the torque which can be achieved during operation is significantly increased.

According to a further embodiment, the permanent magnets are oriented with an edge along the predetermined helix angle. Accordingly, a radial flux double-rotor machine is provided which can also be adjusted and designed with one-piece permanent magnets in accordance with requirements relating to the predetermined helix angle. If the permanent magnets have planar surfaces, the oblique arrangement of the permanent magnets on the inner or outer peripheral surface of the respective annular main bodies gives rise to a slight gap between the permanent magnet and the main body in sections due to the geometry. In the case of an integrally bonded connection of the permanent magnets on the annular main body, this gap is for example filled with the integral bond medium. The integrally bonded connection can be established e.g. by means of a suitable adhesive.

According to a further embodiment, the permanent magnets have an oblique parallelogram shape. The parallelogram-shaped permanent magnets likewise have a, in particular the same, resulting total helix angle in the circumferential direction. In this manner, leaving the surface free or protruding over the surface of the annular main bodies by the permanent magnets can be avoided by reason of the parallelogram shape. This results in optimum utilisation of the surface of the annular main bodies. By reason of the arrangement of the parallelogram-shaped permanent magnets in/on the annular main body, a gap is likewise produced due to the geometry. However, e.g. in the case of an integrally bonded connection of the permanent magnets on the annular main body, this gap can be filled with the integral bond medium. The integrally bonded connection can be established e.g. by means of a suitable adhesive.

According to a further embodiment, the permanent magnets can also be formed as rectangles, in particular narrow rectangles. The respective corners of the permanent magnets can leave a comparatively small surface on the respective annular main body free or protrude beyond it with the corner. Since the dimensioning of the permanent magnets, in particular the width thereof, is selectable, the surface which is left free or is protruding can also be adjusted in this manner. Accordingly, a radial flux double-rotor machine is provided which can be designed in a simple manner in accordance with requirements. In the case of further embodiments, further orientations of the permanent magnets are also feasible, which result in the desired oblique field.

According to one embodiment, the winding is designed to be torsionally stiff such that a torque acting upon the stator core during the operation of a radial flux double-rotor machine can be supported, in particular completely, via the torsionally stiff winding on the support element. In this manner, all other types of force support devices, in particular for the stator core, can be advantageously omitted.

According to a further embodiment, the winding has, in the radially inner part of the stator, a radially inner layer of helically arranged conductor bars, and has, in the radially outer part of the stator, a radially outer layer of oppositely helically arranged conductor bars. In this manner, a bar structure is formed by the winding and has a high torsion stiffness. The conductor bars of the radially inner part of the stator and the conductor bars of the radially outer part of the stator each describe a helical line, of which the turning directions or pitches are opposed to one another. An angle-swept in relation to the centre axis of the stator-of the helical line between the beginning and the end of a conductor bar is designed in particular in such a manner that one conductor loop is formed per pole of the rotors in a radial flux double-rotor machine. The swept angle to be provided can thus be calculated from the quotient of a whole revolution (2π or 360°) and twice the number of pole pairs p.

According to one embodiment, the radially inner layer and the radially outer layer of the winding have in each case the thickness of an individual conductor bar. That is to say that a phase of the winding is formed in each case having the cross- section of an individual conductor bar. Such a winding design in accordance with the invention is made possible, inter alia, by the specific design of the radial flux double-rotor machine which prevents the current displacement to the surface, which is otherwise present in conductors, by means of the magnetic symmetry thereof. This permits comparatively thick conductor cross-sections and a relatively uniform current distribution is still achieved over the cross-section. For example, the thickness of the conductor bars can be in the range of several millimetres. In particular, they can be bars having a square profile with edge lengths of several millimetres, e.g. in the range of 2 mm to 6 mm, in particular in the range of 3 mm to 5 mm. Other cross-sectional shapes are likewise possible.

According to one embodiment, the conductor bars are each twisted corresponding to the helical course such that a cross-section of a conductor bar is the same at each point of the conductor in relation to a radial axis of the cross-section. This relates, in particular, to a torsion of a conductor bar, in particular a non-round conductor bar, about the centre axis of the stator or the machine. Depending upon the course of the helical shape, the conductor bars can additionally also be bent. The inner and outer layers are arranged in an interlaced manner, i.e. rotated, twisted and possibly bent in opposite directions, with respect to one another. In this manner, from a mechanical viewpoint the orientation of a conductor bar is oriented ideally for power transmission with the stator core at each point of the stator core, so that the respective conductor bar is loaded uniformly over its length. Therefore, in the resulting bar structure the conductor bars advantageously absorb predominantly tensile and compressive stresses when subjected to tangential force. In this manner, load peaks and deformations of the conductor bars are avoided. In particular when compared to a design with axis- parallel, straight conductors, the mechanical stresses can thus be significantly reduced.

According to one embodiment, the conductor bars of the radially inner and outer layer associated with the same phase of the winding are connected together in each case at the conductor bar ends, in particular via a radially arranged conductor bar piece and/or by means of an integrally bonded connection. In addition to a conductor loop, this also creates a torsionally stiff bar structure-like construction so that, when an axially accessible winding end is fixed, a high torque can be absorbed by the winding without causing unacceptably large deformations and/or stress states. Therefore, the self-supporting design of the winding is made possible only by the winding material, e.g. copper, without additional support means or elements.

According to a further embodiment, the stator core contains a laminated stator core with stator grooves extending helically corresponding to the winding course, wherein inner stator grooves of the radially inner part of the stator extend according to the first direction of rotation and outer stator grooves of the radially outer part of the stator extend according to the second direction of rotation oppositely with respect to one another. The winding or the self-supporting bar structure formed therewith is embedded in the laminated stator core. In a similar manner to the conductor bars of the winding, the stator grooves change their tangential position in dependence upon the axial position, producing the helical shape. The direction of the change in position follows the conductor bars, i.e. the centre line of the radially outer grooves and the radially inner grooves likewise describe a helical line, of which the turning directions are opposed and correspond to the first or second direction of rotation.

In the case of further embodiments, other types of production known to a person skilled in the art for producing the stator core geometry in accordance with the invention having the radially inner and outer stator grooves extending helically in opposite directions would also be feasible, in particular also additive types of production, such as sintering methods or the like.

According to one embodiment, only one single conductor bar is placed in each stator groove of the laminated stator core. As already explained in relation to the winding, the conductor bars of the inner and outer stator grooves are helically interlaced against one another by torsion about the centre axis of the machine, so that the conductor ends of the inner and outer layers are guided towards one another. The conductor bars are conductively connected together at the conductor bar ends, in particular via a radially arranged conductor bar piece and/or by means of an integrally bonded connection, e.g. by welding or hard soldering.

According to one embodiment, the conductively connected conductor bars of the inner and outer layer together form wave-shaped winding strands. The winding strands can be interconnected to form a rotational field-generating winding with a desired or adjustable number of strands by means of corresponding interconnections which are known to a person skilled in the art. The voltage-retaining number of strand turns is determined directly from the quotient of the number of grooves in the numerator and a product of the number of strands and the number of parallel branches in the numerator. For example, the number of parallel branches is selected to be 1. In this case, the simplest possible interconnection of the winding is produced.

According to one embodiment, the stator sheets of the laminated stator core are formed in each case identically having recesses provided for forming the stator grooves. The helical course of the stator grooves is provided by stacking the stator sheets in a manner rotated with respect to one another. In this manner, the laminated stator core can be manufactured in a very economical way because the same punching die can be used for all stator sheets which are arranged in parallel or are stacked. Accordingly, two adjacent stator sheets are rotated slightly with respect to one another by a predetermined angle about the centre axis so that the recesses are arranged in an overlap with respect to one another, which corresponds to the helical line course.

According to a further embodiment, the laminated stator core contains an inner partial package with radially inner stator grooves and an outer partial package with radially outer stator grooves, wherein the stator sheets of the inner partial package are designed each having an identical geometry and the stator sheets of the outer partial package are each designed having an identical geometry. In addition, the stator sheets of the inner partial package are stacked according to the first direction of rotation of the conductor bars and the stator sheets of the outer partial package are stacked according to the second direction of rotation of the conductor bars, twisted oppositely to one another by a predetermined angle of twist about the centre axis. In a further embodiment, the angle of twist of the stator sheets about the centre axis is identical to the swept angle of the stator grooves. In this manner, the opposite helical lines of the stator grooves can be produced with little manufacturing outlay. Nevertheless, a very economical manufacturing method is still permitted because the same punching die can be used for all parallel or stacked stator sheets of the inner partial package and the same punching die can be used for all parallel or stacked stator sheets of the outer partial package. Accordingly, two adjacent stator sheets of the inner partial package are rotated slightly with respect to one another in a first direction of rotation by a predetermined angle of twist about the centre axis and two adjacent stator sheets of the outer partial package are rotated slightly with respect to one another in a second opposite direction of rotation by a predetermined angle of twist about the centre axis. In this manner, the recesses of the stator sheets of the inner partial package and the recesses of the stator sheets of the outer partial package are arranged in an opposed overlap with respect to one another, which corresponds to the opposed helical line course.

According to one embodiment, the stator sheets of the laminated stator core are formed in each case identically having recesses provided for forming the stator grooves. The helical course of the stator grooves is provided by stacking the stator sheets in a manner rotated with respect to one another. In this manner, the laminated stator core can be manufactured in a very economical way because the same punching die can be used for all stator sheets which are arranged in parallel or are stacked. Accordingly, two adjacent stator sheets are rotated slightly with respect to one another by a predetermined angle about the centre axis so that the recesses are arranged in an overlap with respect to one another, which corresponds to the helical line course.

According to a further embodiment, the stator sheets are formed in each case differently having recesses provided for forming the stator grooves. The helical course of the stator grooves is provided by means of different distances of the recesses in the individual stator sheets. In this respect, an individually matching stator sheet shape is produced in this case for each position of a stator sheet within the stack, wherein the individual geometries can also be repeated within the stack. In this case, the production can be implemented e.g. by means of a beam cutting process, in particular a laser beam cutting process, which is more flexible in terms of shape compared to a punching process. Also feasible would be flexible punching dies having a variable geometry or, in the case of very large quantities, of course a plurality of individual punching dies for each of the different stator sheet shapes.

According to one development, the recesses for radially inner and radially outer stator grooves are each integrally formed in a common stator sheet, wherein the oppositely helical course of the radially inner and radially outer stator grooves is provided by a continuous displacement of the inner and outer stator grooves with respect to one another from stator sheet to stator sheet. In this case, an individually matching stator sheet shape is also produced for each position of a stator sheet within the stack, wherein the individual geometries can also be repeated within the stack. In particular flexible separating processes, such as e.g. laser beam cutting, are also used in this case for production purposes. The one-piece production of the inner and outer recesses which is thus possible advantageously reduces the number of parts.

According to one embodiment, the stator sheets have straight, in particular punched, edges. A width of the recesses provided for the stator grooves is larger than the width of the conductor bars by an amount which is predetermined by the pitch of the helical shape of the course of the stator grooves and by the sheet thickness of the stator sheets. A clear width or continuous width of the stator grooves which is reduced by reason of the offset between the recesses of the stator sheets thus corresponds substantially to the width of a conductor bar. In practice, the continuous clear width of the stator groove is provided slightly larger than the width of the conductor bar in order to provide a clearance fit necessary for introducing the conductor bars. The edge of a stator groove thus describes a staircase shape with the respective sheet thickness as steps, on which the conductor bar is uniformly supported. In this manner, torque support is made possible uniformly over the entire thickness of the laminated stator core or over the entire length of the conductor bars accommodated in the laminated stator core.

According to one embodiment, an angle swept in each case by the stator grooves is smaller than an angle swept in each case by the conductor bars. The swept angle relates in each case to a rotation about the centre axis of the stator. The difference in the swept angles arises by reason of the fact that the conductor bars protrude axially beyond the stator core and are thus longer than the stator grooves. Since the helical course likewise continues, a larger angle swept thereby is produced. The stated difference is provided so as to ensure sufficient accessibility of the winding ends for connecting, in particular welding, the conductor bar ends after introduction into the stator grooves. Furthermore, this enables the winding to engage with the support device or the support element thereof in a manner axially offset with respect to the stator core.

From the quotient of the swept angles, i.e. a ratio of the angle swept by each of the stator grooves to the angle swept by each of the conductor bars, a so-called pole coverage degree can be defined for the laminated stator core.

According to one embodiment, a ratio of the angle swept by each of the stator grooves to the angle swept by each of the conductor bars is in a range between 0.6 and 0.8, in particular between 0.6 and 0.75, for example between 0.6 and 0.7. This ratio (pole coverage degree) provides in this range an optimum between losses, produced by current heat, and torque utilisation.

According to one embodiment, the winding protrudes, at at least one axial end, beyond the stator core. Furthermore, a support device is provided which is arranged axially offset with respect to the stator core and is designed for form-fitting engagement with the winding at the at least one axial end for torque support.

According to one embodiment, the support device has a support element, in which support grooves are provided which correspond to the helical arrangement of the conductor bars and are in engagement with the conductor bars. In this manner, form-fitting embedding of the conductor bars into the support element is provided for the support of the torque at the axial end. For example, there is engagement with all conductor bars so that torque support is homogeneously or uniformly transferred over the entire bar structure of the winding.

In order to transmit the torque, the support element can be coupled to a mechanically fixed base of a radial flux double-rotor machine. For this purpose, one possible embodiment provides through-bores for force-fitting fastening means, such as screws, but of course form-fitting connection means or an integrally bonded connection would also be feasible.

According to one embodiment, the support grooves follow, at least in sections, the helical course of the twisted conductor bars. In particular, the support grooves have a similarly twisted course like the conductor bars. For example, the support element is substantially annular and has recesses on the inner and/or outer periphery which are oriented radially and correspond to the course of the conductor bars.

According to one embodiment, the support device has a radially inner support element for engagement with the radially inner layer of the conductor bars, and has a radially outer support element for engagement with the radially outer layer of the conductor bars. In this embodiment, the support elements can be annular, wherein the inner support element has, on its outer periphery, grooves or teeth corresponding to the course of the inner layer of the conductor bars for receiving the radially inner conductor bars in a form-fitting manner, and the outer support element has, on its inner periphery, grooves or teeth corresponding to the course of the outer layer of the conductor bars for receiving the radially outer conductor bars in a form-fitting manner. The grooves or teeth follow in particular the respective helical course. By reason of the arrangement on the inner or outer periphery, the recessed grooves are easily accessible for mechanical processing, which simplifies the production of the support elements.

According to a further embodiment, the resulting total helix angle in the circumferential direction of the permanent magnets of the inner rotor is in a range of 20% to 40%, for example 25% to 35%, for example 28% to 32% of the angle of twist of the stator sheets of the inner partial package and/or the resulting total helix angle in the circumferential direction of the permanent magnets of the outer rotor is in a range of 20% to 40%, for example 25% to 35%, for example 28% to 32 of the angle of twist of the stator sheets of the outer partial package. By reason of the fact that the field distortion does not fully follow the course of the stator grooves of the respective stator sheets, the resulting total helix angle of the permanent magnets of the inner and outer rotor is smaller than the angle of twist of the stator sheets. In this manner, an exemplary design is provided which effects an optimised torque increase by reason of the relationship between the angle of twist of the stator sheets and the resulting total helix angle of the permanent magnets.

According to a further embodiment, the permanent magnets of the inner rotor and the outer rotor have a predetermined tangential width, wherein the stator core has a radial yoke thickness which is in the range of 5% to 25%, for example 10% to 20%, for example 12.5% to 17.5% of a tangential pole width. The tangential pole width is, in particular, a local tangential pole width and constitutes for example the common tangential width of all permanent magnets of a pole.

Furthermore, a maximum tangential pole width in the cross-section of the machine is determined arithmetically from a quotient of the radius of the machine multiplied by one complete revolution (2π or 360°) and twice the number of pole pairs p. The radial yoke thickness of the stator core can be increased in order to support a certain tangential flux carrying at the ends of the radial flux double-rotor machine and thus to reduce the magnetic resistance. The used radial yoke thickness of the stator can thus be increased slightly with respect to conventional yokeless designs but without significantly increasing the weight of the laminated stator core.

According to one embodiment, the stator core is still designed primarily for carrying a radial magnetic flux. This is therefore still a so-called “yokeless” design of the stator core which has, in particular in the axial centre of the machine, no significant magnetic flux carrying in a peripheral or tangential direction.

According to one embodiment of a radial flux double-rotor machine, the support elements are fixed to the base and thus guide the torque to the fixed part of the electric machine. For this purpose, the support elements can be fastened individually with the base, e.g. a housing, of the machine. Alternatively or in addition, the inner and outer support elements can be fastened together.

According to one embodiment of a stator, the support device contains a heat-conducting material, in particular a metal, for example an aluminium alloy. In particular, both support elements can contain such a material. This permits not only a high mechanical strength but also heat dissipation from the winding via the support device.

According to one embodiment of a corresponding radial flux double-rotor machine having a support device which contains a heat-conducting material, the base additionally has a heat sink which is designed to absorb heat dissipated via the support device from the stator, in particular from the winding. As a result, the support device has a high mechanical strength and at the same time ensures a good thermal connection of the winding to the heat sink. For example, the housing of the machine can serve as the heat sink. Alternatively or in addition, the support device, for example the inner and outer support elements, can be in thermal contact with an actively cooled heat sink of the machine. In this manner, the current heat losses produced in the winding or in the conductor bars can be effectively dissipated.

According to one embodiment of a radial flux double-rotor machine, a predetermined number of pole pairs are provided both on the first rotor and on the second rotor. An angle swept by each of the conductor bars is designed to form a conductor loop for each pole of the rotors. The swept angle to be provided can thus be calculated from the quotient of a whole revolution (2π or 360°) and twice the number of pole pairs p.

A further aspect of the disclosure relates to a method of producing a stator, comprising the steps of: providing a stator core having radially outer stator grooves describing in each case a helical line and having a first direction of rotation, and radially inner stator grooves describing in each case a helical line with an opposite direction of rotation; introducing individual conductor bars following the helical lines through the inner and outer stator grooves; and connecting the conductor bars, which are introduced into the inner and outer stator grooves, at the conductor bar ends to form conductor loops.

According to one embodiment of the production method, providing the stator core comprises producing a laminated stator core, wherein individual stator sheets which have recesses for forming stator grooves are stacked in a twisted manner with respect to one another. In this manner, the laminated stator core can be manufactured in a very economical way because the same punching die can be used for all stator sheets which are arranged in parallel or are stacked. Accordingly, two adjacent stator sheets are rotated slightly with respect to one another by a predetermined angle about the centre axis so that the recesses are arranged in an overlap with respect to one another, which corresponds to the helical line course. The individual stator sheets are produced with such a geometry for example by punching or laser beam cutting of individual laminations of electrical steel.

According to one development of the method, the laminated stator core contains an inner partial package and an outer partial package, wherein all stator sheets of the inner partial package are designed having an identical geometry in each case and all stator sheets of the outer partial package are designed having an identical geometry in each case, and wherein the stator sheets of the inner partial package for forming the inner stator grooves and the stator sheets of the outer partial package for forming the outer stator grooves are stacked in a manner twisted oppositely with respect to one another. In this case, all sheets of the respectively inner and outer package can be designed having the same geometry, thus making the production process very economical. Therefore, the same punching die can be used for all stator sheets of the inner partial package which are arranged in parallel or are stacked, and the same punching die can be used for all stator sheets of the outer partial package which are arranged in parallel or are stacked. Two adjacent stator sheets of the inner partial package are rotated slightly with respect to one another in a first direction by a predetermined angle about the centre axis and two adjacent stator sheets of the outer partial package are rotated slightly with respect to one another in a second direction by a predetermined angle about the centre axis. In this manner, the recesses of the stator sheets of the inner partial package and the recesses of the stator sheets of the outer partial package are arranged in an opposed overlap with respect to one another, which corresponds to the opposed helical line course. In this manner, the opposite helical lines of the stator grooves can be produced with little manufacturing outlay.

According to a further embodiment of the method, the laminated stator core has a large number of differently formed stator sheets, wherein the recesses for the inner and outer stator grooves are integrated in each case in a common stator sheet, and wherein the pitch of the helical line is achieved by means of a continuous displacement of the inner and outer stator grooves with respect to one another from stator sheet to stator sheet, in particular with a flexible punching or laser beam separation process. The inner and outer stator grooves are integrated into a single stator sheet (lamination) and the helical course of the stator grooves is achieved in each individual sheet by means of a continuous displacement of the recesses with respect to one another in the separation process, e.g. by means of a flexible punching process or a laser beam separation process. This has the advantage that fewer parts also means that fewer manufacturing steps are required and the stator sheet thus produced or the entire stator core has greater mechanical strength.

In a further embodiment, the method further comprises the step of providing a support device which is designed for form-fitting engagement with the conductor bar ends at at least one axial end for torque support, and the step of bringing the support device into form-fitting engagement with the conductor bar ends at the at least one axial end at a position arranged axially offset with respect to the stator core.

Furthermore, according to one aspect the stator produced in this manner can be used for performing a method for producing a radial flux double-rotor machine, comprising the further steps of: providing a mechanically fixable base and a support device which is designed for form-fitting engagement with the winding at the at least one axial end for torque support, fastening the support device to the base, and providing a double rotor which has an inner rotor and an outer rotor, wherein the inner rotor and the outer rotor each have an annular main body which is designed for carrying flux, and a common centre axis, wherein a plurality of permanent magnets are fastened in each case to the annular main body and each permanent magnet is allocated in the cross-section a predetermined angle segment of the annular main body, wherein the permanent magnets are formed and arranged on the respective main body such that the angle segment is displaced in the axial progression in the circumferential direction so that the permanent magnets generate a field which extends obliquely with respect to the centre axis, wherein a field of the inner rotor extends obliquely in a first direction which is oriented to the first direction of rotation, and wherein a field of the outer rotor extends obliquely in a second direction which is oriented to the second direction of rotation.

The above embodiments and developments can be combined with each other in any manner if it is useful to do so. In particular, all of the features of the stator can be transferred to the method for producing a stator, and vice versa. Furthermore, all of the features of the stator can be transferred to a corresponding radial flux double-rotor machine and to a vehicle axle having such a radial flux double-rotor machine and/or a vehicle having such a vehicle axle.

Further possible embodiments, developments and implementations of the invention also comprise non-explicitly-mentioned combinations of features of the invention which have been described or will be described hereinafter with reference to the exemplified embodiments. In particular, in this regard a person skilled in the art will also add individual aspects as improvements or complements to the respective basic form of the present invention.

### BRIEF DESCRIPTION OF THE DRAWING

The present invention will be explained in more detail hereinafter with the aid of the exemplified embodiments shown in the schematic figures of the drawing. In the drawing:

FIG. 1 shows an exploded view of a radial flux double-rotor machine having a stator and a double rotor;

FIG. 2 shows an exploded view of a double rotor;

FIG. 3 shows a plan view of two axial segments of a permanent magnet;

FIG. 4 shows a schematic cross-sectional view of a portion of an inner and outer rotor having permanent magnets;

FIG. 5 shows a plan view of a parallelogram-shaped permanent magnet;

FIG. 6 shows a schematic cross-sectional view of a portion of an inner and outer rotor having parallelogram-shaped permanent magnets;

FIG. 7 shows a perspective view of a winding;

FIG. 8 shows a perspective view of a stator core;

FIG. 9 shows a cross-sectional view of a radial flux double-rotor machine;

FIG. 10 shows a cross-sectional view of a radial flux double-rotor machine according to a further embodiment;

FIGS. 11A-C show cross-sectional views of a radial flux double-rotor machine at different axial positions with field distortion indicated;

FIG. 12 shows a schematic longitudinal sectional view of a stator;

FIG. 13 shows a schematic longitudinal sectional view of a radial flux double-rotor machine;

FIG. 14 shows an exploded view of a radial flux double-rotor machine according to one embodiment;

FIG. 15 shows an exploded view of a stator according to one embodiment;

FIG. 16 shows an exploded view of a radial flux double-rotor machine according to a further embodiment;

FIG. 17 shows a perspective view of the radial flux double-rotor machine as shown in FIG. 16 in the mounted state;

FIG. 18 shows a perspective longitudinal sectional view of a radial flux double-rotor machine according to a still further embodiment;

FIG. 19 shows an exploded view of a laminated stator core of a stator core;

FIG. 20 shows a schematic longitudinal sectional view of a stator groove;

FIG. 21 shows a plan view of a winding;

FIG. 22 shows a perspective view of an FEM simulation of a winding under load;

FIG. 23 shows a perspective view of an FEM simulation of a comparative winding under load with the conductor bars having a straight design; and

FIG. 24 shows a flow diagram of a method for producing a stator.

The attached figures of the drawing are intended to provide improved understanding of the embodiments of the invention. They illustrate embodiments and are used in conjunction with the description to explain principles and concepts of the invention. Other embodiments and many of said advantages will be apparent in view of the drawings. The elements in the drawings are not necessarily illustrated to scale with respect to each other.

In the figures of the drawing, like and functionally identical elements, features and components and elements, features and components acting in an identical manner are provided with the same reference signs, unless indicated otherwise.

### DETAILED DESCRIPTION OF EMBODIMENTS

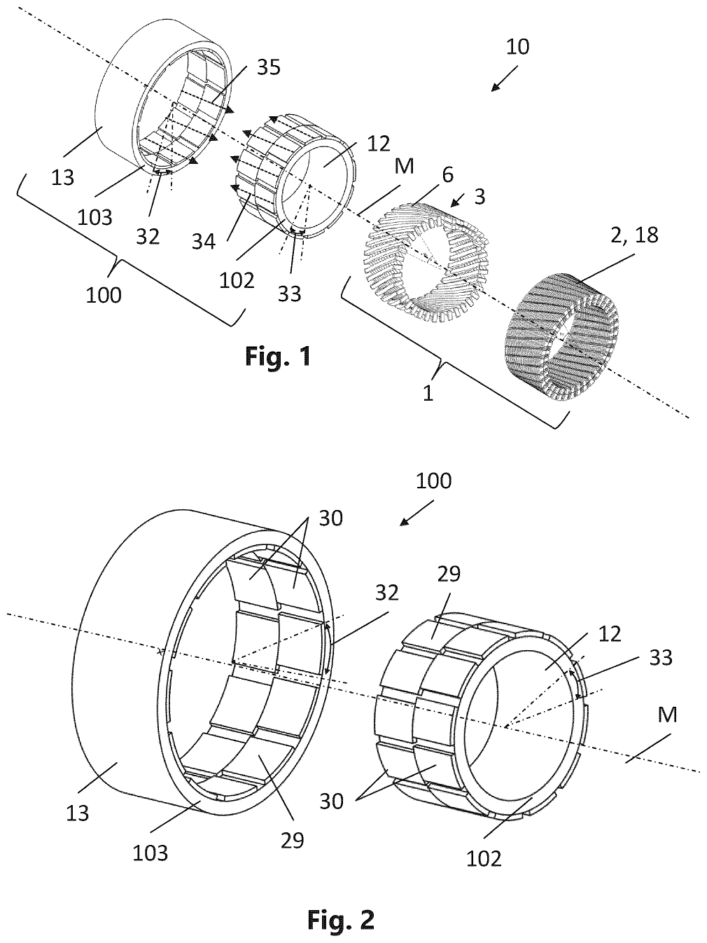

FIG. 1 shows an exploded view of a radial flux double-rotor machine 10 having a stator 1 and a double rotor 100.

The stator 1 and double rotor 100 of the radial flux double-rotor machine 10 have a common centre axis M. The stator 1 is received concentrically between the inner rotor 12 and outer rotor 13 of the double rotor 100.

The stator 1 has a stator core 2 and a torsionally stiff winding 3 received therein. In a radially inner part of the stator 1, the conductor bars 6 of the torsionally stiff winding 3 extend helically in a first direction of rotation. In a radially outer part of the stator 1, the conductor bars 6 of the torsionally stiff winding 3 extend helically in an opposite second direction of rotation.

The double rotor 100 has an inner rotor 12 and an outer rotor 13. The inner rotor 12 and the outer rotor 13 each have an annular main body 102, 103. The annular main body 102, 103 are designed for carrying flux and have a common centre axis M. A plurality of permanent magnets 29 are fastened in each case to the annular main bodies 102, 103. Each permanent magnet 29 is allocated in the cross-section a predetermined angle segment 32, 33 of the annular main body 102, 103. The predetermined angle segments 32, 33 extend in an arcuate manner along the circumference of the annular main bodies 102, 103.

The permanent magnets 29 are designed and arranged on the respective annular main body 102, 103 such that the predetermined angle segment 32, 33 is displaced in the axial progression in the circumferential direction and so the permanent magnets 29 generate a field 34, 35 which extends obliquely with respect to the centre axis M. The field 34 of the inner rotor 12 extends obliquely in a first direction which is oriented to the first direction of rotation of the torsionally stiff winding 3. The field 35 of the outer rotor 13 extends obliquely in a second direction which is oriented to the second direction of rotation of the torsionally stiff winding 3.

The fields 34, 35 of the permanent magnets 29 extending in each case oppositely in an oblique manner are illustrated in FIG. 1 by the oblique dotted arrows. The field propagation lines of the fields 34, 35 extend, as indicated, oppositely in an oblique manner over the permanent magnets 29 of the inner rotor 12 and outer rotor 13.

The configuration and arrangement of the permanent magnets 29 for displacement of the angle segment 32, 33 in the axial progression is not restricted to the design illustrated in this case, but instead can be modified in various ways.

FIG. 2 shows an exploded view of a double rotor.

The double rotor 100 has an inner rotor 12 and an outer rotor 13. The inner rotor 12 is received concentrically within the outer rotor 13. A plurality of permanent magnets 29 are arranged on the inner surface of the annular main body 103 of the outer rotor 13.

The permanent magnets 29 are allocated in the cross-section a predetermined angle segment 32 of the annular main body 103. As illustrated in FIG. 2, the angle segment 32 is displaced in the axial progression in the circumferential direction and the adjacent axial segment 30 of the permanent magnet is accordingly arranged in an axially displaced manner in the circumferential direction.

In this case, the permanent magnets 29 are divided by way of example into a plurality of axial segments 30. However, in further embodiments it is also feasible to have other configurations and arrangements of the permanent magnets 29 for displacement of the angle segment 32, 33 in the axial progression.

This geometric relationship is likewise provided on the outer surface of the annular main body 102 of the inner rotor 12. In further embodiments, as an alternative or in addition to the illustrated arrangement of the permanent magnets on the surface of the inner and outer rotors 12, 13, the permanent magnets 29 can also be countersunk within the annular main bodies 102, 103. Furthermore, the annular main bodies 102, 103 are manufactured from solid material.

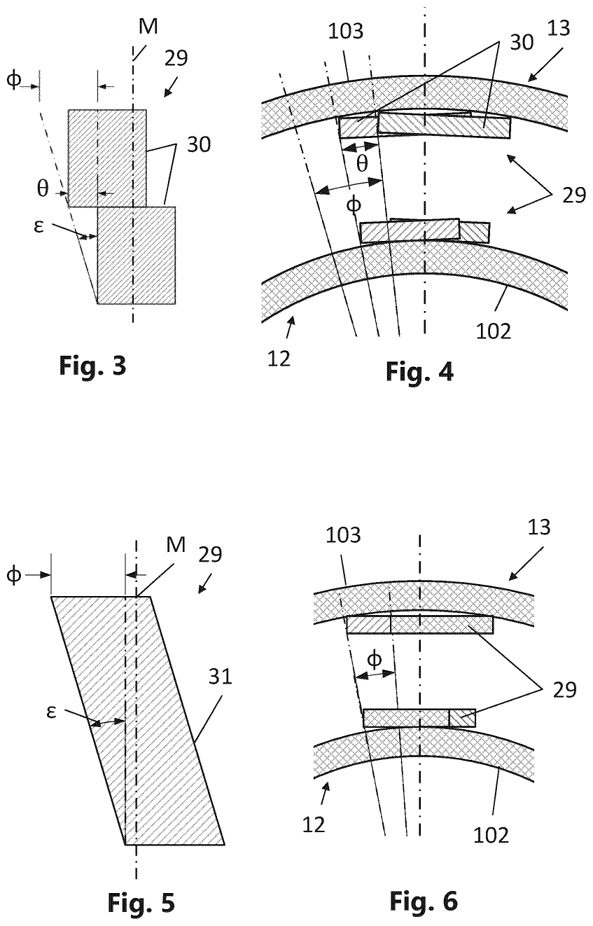

FIG. 3 shows a plan view of a permanent magnet 29.

The permanent magnet 29 is arranged at an exemplary predetermined helix angle & relative to the axial direction of the centre axis M on the annular main body 102, 103 (not illustrated).

The illustrated permanent magnet 29 is divided by way of example into a plurality of axial segments 30. An axial segment 30 is allocated in each case an angle segment 32, 33 (not illustrated) of the respective main body, said angle segment being displaced with respect to the adjacent axial segment 30 by a setting angle θ about the centre axis M.

The resulting total helix angle ϕ of the permanent magnet is determined by reason of geometry from the setting angle θ, in particular from a multiple of the setting angle θ. In the case of a predetermined number of n axial segments 30 per permanent magnet 29, the resulting total helix angle ϕ is determined from the setting angle θ with the relation, ϕ=n*θ. In addition, the predetermined helix angle ε indicated by way of example in this case is configured as a function of the length of the radial flux double-rotor machine 10. In further embodiments, a predetermined helix angle can also be defined in a manner different to that illustrated. In this respect, ε is shown in FIG. 3 purely by way of example as a projected angle on the peripheral surface of the permanent magnet 29.

As illustrated in FIG. 3, the axial segments 30 in the illustrated embodiment are arranged with the long edge in parallel with the centre axis M. In this embodiment, this results in optimum utilisation of the surface of the annular main bodies 102, 103. According to a further embodiment, an edge of the axial segments 30 can be arranged on the annular main body 102, 103 at a specific angle with respect to the centre axis, e.g. the edge of the axial segments 30 can be oriented along the predetermined helix angle ε. Furthermore, in further embodiments other orientations of the axial segments 30 which result in the desired total helix angle of the arrangement are also possible on the surface of the annular main body 102, 103.

FIG. 4 shows a schematic cross-sectional view of a portion of an inner and outer rotor 12, 13 having permanent magnets 29.

The permanent magnets 29 shown are each arranged in the axial direction one behind the other on the annular main bodies 102, 103, as illustrated in FIG. 3. Also indicated are the resulting total helix angle ϕ and the setting angle θ about the centre axis M (not illustrated) of the radial flux double-rotor machine 10.

The displacement of the respective two axial segments 30 with respect to one another in the circumferential direction is described by the setting angle θ. By reason of the concentric arrangement of the annular main body 102, 103 and the exclusively radially offset arrangement of the axial segments 30 on the respective annular main bodies 102, 103, the setting angle θ of the permanent magnets 29 is oppositely equal in value on the inner and outer rotor 12, 13. This arrangement of the axial segments 30 is also decisive for the function of the double rotor 100.

As already mentioned, the resulting total helix angle ϕ in the circumferential direction is determined from the setting angle θ of the axial segments 30 and the number of the axial segments 30. Furthermore, in the case of the rectangular design of the axial segments 30 of the permanent magnets 29 having a planar surface, a gap is provided between the respective axial segments 30 and the inner or outer peripheral surfaces of the annular main bodies 102, 103. This gap can be filled, e.g. in the case of an integrally bonded connection of the axial segments 30 of the permanent magnets 29 to the annular main bodies 102, 103, with a integral bond medium. The integrally bonded connection can be established e.g. by means of a suitable adhesive. However, it should be noted that further mechanisms and methods for fastening would be possible, in particular also those in which no gap is produced between the respective axial segments 30 and the annular main bodies 102, 103. Alternatively or in addition, e.g. local recesses of the rotor are feasible for the purpose of compensating for gaps. Furthermore, the inner and outer permanent magnets in further embodiments can be identical in size or, as illustrated here, can be different in size, for example in order to cover an identical angle segment in the radial orientation.

FIG. 5 shows a plan view of a parallelogram-shaped permanent magnet 29.

The shape of the axial segments 30 or the permanent magnets 29 can deviate from the rectangular shape of FIG. 3, as shown in FIG. 5. The illustrated permanent magnet 29 has a parallelogram shape, wherein the diagonal edges 31 of the permanent magnet 29 are inclined at a predetermined helix angle & in relation to the axial direction of the centre axis M. In this respect, an identical resulting total helix angle o is produced in the circumferential direction about the centre axis M of the permanent magnets 29. When using parallelogram-shaped permanent magnets 29, the surface of the annular main bodies 102, 103 (not illustrated) can be optimally utilised and the permanent magnets 29 do not protrude and the surface is not left free.

FIG. 6 shows a schematic cross-sectional view of a portion of an inner and outer rotor 12, 13 having parallelogram-shaped permanent magnets 29.

In a similar manner to that already explained with respect to FIG. 4, it is possible to see the indicated resulting total helix angle o in the circumferential direction about the centre axis M. The resulting total helix angle o describes the swept angle in the circumferential direction, which is produced by the diagonal edge 31 (not illustrated) of the respective permanent magnet 29. The problem described in relation to FIG. 4 with the production of a gap at the inner and outer rotor 12, 13 can be solved in a similar manner in the parallelogram-shaped permanent magnets 29 illustrated. The placement of the permanent magnets 29 on the annular main bodies 102, 103 with respect to one another is provided in dependence upon the resulting total helix angle ϕ. The total helix angle ϕ in relation to the circumferential direction is oppositely equal in value for the illustrated permanent magnets 29 on the inner and outer rotor 12, 13 by reason of the opposite direction of rotation.

In the case of the illustrated embodiment, the inner and outer permanent magnets 29 can be different in size in order to cover an identical angle segment in the radial orientation.

However, the inner and outer permanent magnets in further embodiments can also be identical in size, e.g. for reducing costs within the scope of a one-piece strategy.

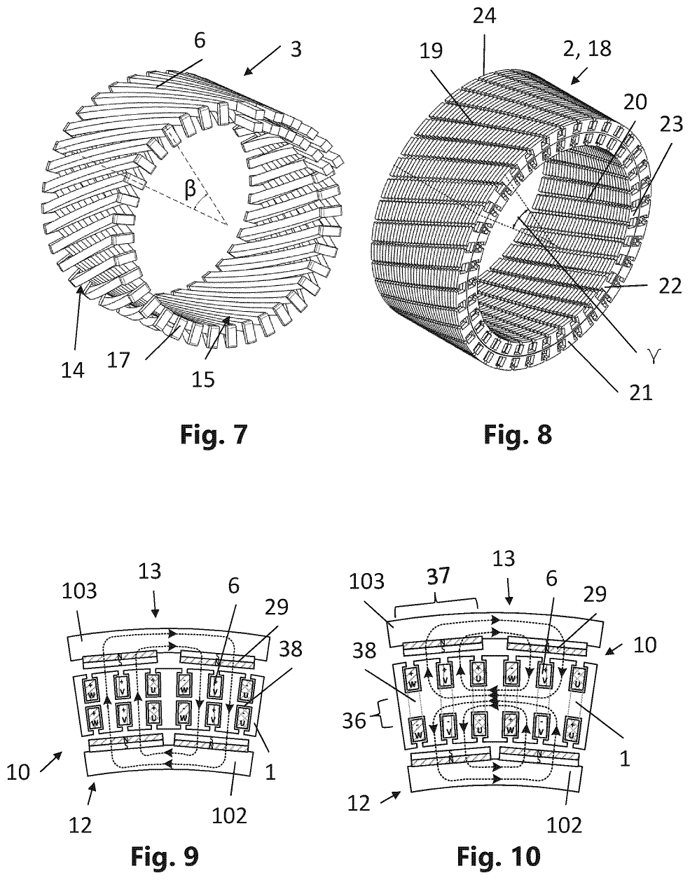

FIG. 7 shows a perspective view of a winding 3.

The winding 3 is constructed from said conductor bars 6 which extend helically along the centre axis M. For this purpose, the conductor bars 6 are not only arranged in a correspondingly interlaced manner, but are also twisted in one another according to the helical line course.

The swept angle β of the conductor bars 6 identifies the angle between the start and end of a conductor bar 6 relative to the centre axis M. Since the pitch of the helical line of the conductor bars 6 is equal to the pitch of the helical line of the stator grooves 19, 20, but the conductor bars 6 are longer than the stator grooves, a ratio of the respective swept angles α and β can be formed in order to characterise the geometric relationships, which is also referred to as the pole coverage degree. In order to provide an optimum between magnetic losses and torque utilisation of a radial flux double-rotor machine, this ratio (pole coverage degree) is for example in a range between 0.6 and 0.75.

The opposed rotation and torsion of the inner and outer radial layers 14, 15 of conductor bars 6 can likewise be seen in this case. The torsion is configured such that the cross-section in relation to a radial line through the centre of the conductor bar is always identical at each point on the conductor rod, as also defined as 2.5 D geometry. Therefore, the conductor bar ends of the inner and outer layers 14, 15 are arranged in an identical orientation one above the other. The conductor bars 6 of the radial inner and outer layers 14, 15 can thus be conductively connected in a simple manner, in this case by way of example via a radially extending conductor bar piece 17 which is welded to the conductor bars 6.

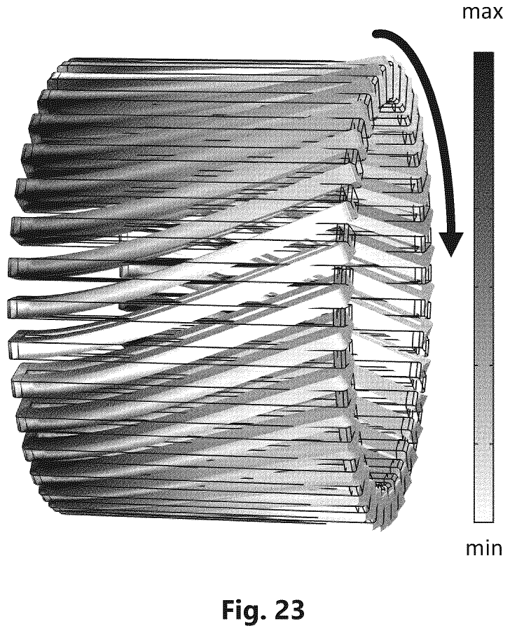

It is to be noted that the winding illustrated here is produced per se not individually but instead always in combination with the stator core 2, which will be discussed in greater detail in relation to FIG. 23.

The winding 3 has, in the radially inner part of the stator 1 (not illustrated), a radially inner layer 15 of helically arranged conductor bars 6, and has, in the radially outer part of the stator 1, a radially outer layer 14 of oppositely helically arranged conductor bars 6.

FIG. 8 shows a perspective view of stator core 2.

The stator core 2 contains a laminated stator core 18 with the winding course corresponding to helically extending stator grooves 19, 20. The inner stator grooves 20 of the radially inner part of the stator 1 (not illustrated) extend according to the first direction of rotation and outer stator grooves 19 of the radially outer part of the stator 1 extend according to the second direction of rotation oppositely with respect to one another.

The laminated stator core 18 contains an inner partial package 23 having radially inner stator grooves 20 and an outer partial package 24 having radially outer stator grooves 19. The stator sheets 22 of the inner partial package 23 are each produced having an identical geometry and the stator sheets 21 of the outer partial package 24 are each produced having an identical geometry. The stator sheets 22 of the inner partial package 23 are stacked according to the first direction of rotation of the conductor bars 6 (not illustrated) and the stator sheets 21 of the outer partial package 24 are stacked according to the second direction of rotation of the conductor bars 6, twisted oppositely to one another by a predetermined angle of twist γ about the centre axis M. The indicated angle of twist γ describes the angle in the circumferential direction relative to the centre axis M between the axial ends of the laminated stator core 18 which is produced by the rotation of the individual stator sheets 21, 22 with respect to one another.

In a particular embodiment, the swept angle of the stator grooves a is identical to the angle of twist γ.

Since the field distortion does not fully follow the course of the stator grooves, the resulting total helix angle ϕ in the circumferential direction is for example smaller than the angle of twist γ. Accordingly, the resulting total helix angle ϕ in the circumferential direction (not illustrated) of the permanent magnets 29 of the inner rotor 12 is in a range of 20% to 40% of the angle of twist γ of the stator sheets 22 of the inner partial package 23 and/or the resulting total helix angle ϕ in the circumferential direction of the permanent magnets 29 of the outer rotor 13 is in a range of 20% to 40% of the angle of twist γ of the stator sheets 21 of the outer partial package 24. The described adaptation of the resulting total helix angle ϕ in the circumferential direction to the angle of twist γ produces a maximum increase in the torque.

FIG. 9 shows a cross-sectional view of a radial flux double-rotor machine 10.

The illustrated arcuate portion of the radial flux double-rotor machine 10 shows conductor bars 6, permanent magnets 29, stator 1, inner rotor 12, outer rotor 13 and annular main bodies 102, 103. Furthermore, the magnetic flux is also indicated in the tangential direction in the inner and outer rotors 12, 13 and in the radial direction of the stator 1. In the illustrated embodiment, the stator 1 is “yokeless”. Therefore, although a stator yoke 38 extends between the conductor bars 6, it serves merely to mechanically hold together the laminated stator core 18 (not illustrated) of the stator 1. As illustrated in FIG. 9, the stator yoke 38 is located in the functionally relevant magnetic flux. However, in the case of the illustrated embodiment of the radial flux double-rotor machine 10, there is a reduction in the tangential magnetic flux-carrying at the axial ends of the radial flux double-rotor machine 10. This has a negative effect on the degree of efficiency of the radial flux double-rotor machine 10 and accordingly there is an undesired reduction in torque.

FIG. 10 shows a cross-sectional view of a radial flux double-rotor machine 10 according to a further embodiment.

The embodiment of the radial flux double-rotor machine 10 illustrated in FIG. 10 has a considerably thicker stator yoke 38 (not to scale) compared to the embodiment of FIG. 9. The stator yoke 38 is described by the indicated radial yoke thickness 36.

The permanent magnets 29 of the inner rotor 12 and of the outer rotor 13 each have a predetermined tangential width 37. In the case of an embodiment, the stator core 2 has a radial yoke thickness 36 which is in the range of 10% to 20% of the tangential width 37 of the permanent magnets 29. Therefore, it is possible to support the tangential flux-carrying at the axial ends of the radial flux double-rotor machine 10.

In one embodiment having permanent magnets 29 which have a parallelogram shape, the cross-section of the permanent magnets 29 is decisive for the relationship between the tangential width 37 of the permanent magnets 29 and the radial yoke thickness 36.

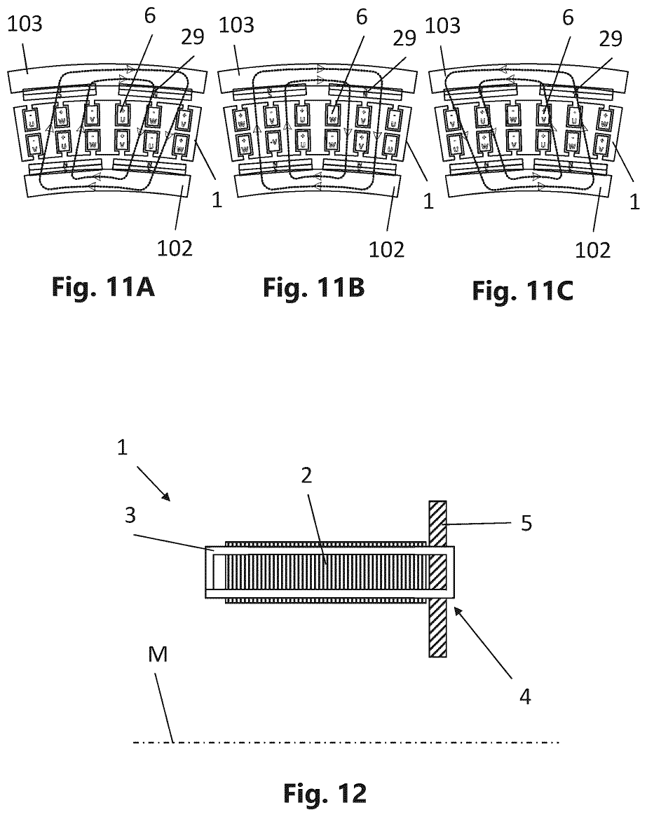

FIGS. 11A-C show cross-sectional views of a radial flux double-rotor machine 10 with indicated field distortion.

The three cross-sectional views (FIG. 11A on the left, FIG. 11B in the middle, FIG. 11C on the right) each describe an axial position within a radial flux double- rotor machine 10. The left cross-sectional view shows a front end, the middle cross-sectional view shows the axial centre and the right cross-sectional view shows a rear end of a radial flux double-rotor machine 10.

The radial flux double-rotor machine 10 illustrated in this case includes one-piece permanent magnets 29 which are arranged in the axial direction. As can be seen in FIG. 11, only the radial flux double-rotor machine 10 in the middle cross-sectional view includes a uniform magnetic field, wherein the field lines in the stator 1 extend exclusively in a radial direction. In the left and right cross-sectional view of the radial flux double-rotor machine 10, field distortion occurs as indicated. The respective field lines are correspondingly inclined in the left and right cross-sectional view, in particular within the respective stator.

In addition, a displacement of the conductor bars 6 via the axial position of the radial flux double-rotor machine 10 (front end, axial centre, rear end) is apparent from the three cross-sectional views. It is only in the middle view where the conductor bars 6 of the same strand (U, V, W) and same current direction (+, −) lie one above the other. Consequently, the magnetic field has its maximum amplitude only in the axial centre of the radial flux double-rotor machine 10. By reason of the underlying geometric relationship between the conductor bars 6 and the permanent magnets 29, the amplitude of the magnetic field is reduced towards the two axial ends (cross-sectional view on the left and right) of the radial flux double-rotor machine 10. The distortion of the magnetic field resulting therefrom results in a reduction in the torque because the permanent magnets in the rotors are no longer in the position which is optimal in each case for torque generation. This is counteracted by the arrangement and configuration of the permanent magnets 29 described with reference to FIGS. 1 to 6 on the respective annular main body 102, 103 in the axial progression in the circumferential direction, so that the permanent magnets 29 generate a field 34, 35 extending obliquely with respect to the centre axis M, which is then arranged optimally within the field distortion.

FIG. 12 shows a schematic longitudinal sectional view of a stator 1.

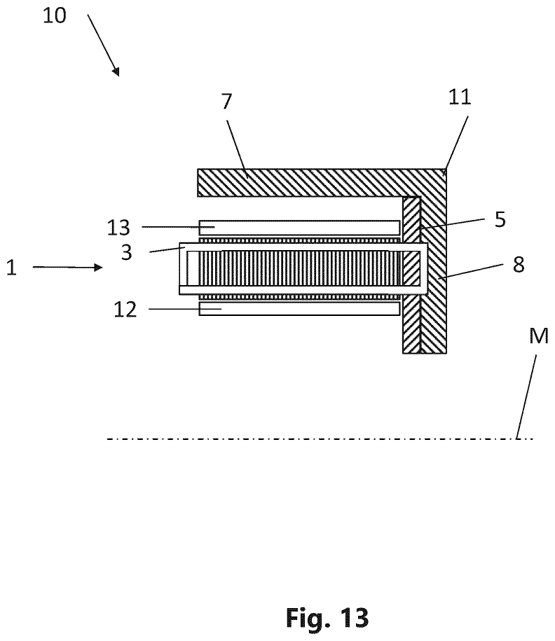

This is a schematic diagram of a stator 1 for a radial flux double-rotor machine 10 (see in this respect FIG. 13), in particular for a wheel hub motor. The stator has a stator core 2, a winding 3 and a support device 5. The stator core 2, the winding 3 and the support device 5 are designed to be rotationally symmetrical about the indicated centre axis M.

The winding 3 is self-supporting for torque support of the stator 1 and protrudes beyond the stator core 2 at at least one axial end 4. The support device 5 is arranged axially offset with respect to the stator core 2 and is form-fittingly connected to the winding 3 at at least one axial end 4 for torque support. In this manner, a torque present at the stator core 2 during the operation of a radial flux double-rotor machine 10 can be supported by means of the self-supporting winding 3 on the support device 4.

The winding contains a conductor material having a low electrical resistance, for example copper. The stator core 2 is constructed for example from a soft-magnetic material for magnetic flux carrying. The support device contains for example a heat-conducting material, e.g. an aluminium alloy. Of course, the winding 3 is electrically isolated.

FIG. 13 shows a schematic longitudinal sectional view of a radial flux double-rotor machine 10.

This is also a purely illustrative schematic diagram. Accordingly, the radial flux double-rotor machine 10 has, in addition to the stator 1 shown in FIG. 12, a mechanically fixed base 11, a first rotor 12 and a second rotor 13. The stator core 2, the winding 3, the support device 5, the base 11, the first rotor 12 and the second rotor 13 are likewise designed to be rotationally symmetrical about the indicated centre axis M.

The winding 3 is self-supporting for torque support of the stator 1 and protrudes beyond the stator core 2 at at least one axial end 4 and is supported on the base 11 via the support device 5. The support device 5 is arranged axially offset with respect to the stator core 2 and is form-fittingly connected to the winding 3 at at least one axial end 4 for torque support. Again, the support device 5 is fastened to the base so that the torque can be supported via the support device 5 on the base 11.

The first rotor 12 is arranged radially within the stator core 2 and the second rotor 13 is arranged radially outside the stator core 2. The base 11 can be designed e.g. as a housing of the machine and in this case comprises in a purely illustrative manner an L-shaped structure which is illustrated having two limbs 7, 8. The illustration is not to be understood as exhaustive, on the contrary the base can have further components and/or structural portions. The first limb 7 extends substantially radially, the second limb 7 extends substantially axially with the greatest distance with respect to the centre axis M.

Purely schematically, the support device 5 is illustrated in one part extending in a radial manner, but it can also be provided in multiple parts and/or with another geometry configured for form-fitting connection to the winding 3. The illustrated overlap of the winding 3 with the base 11 is purely due to the illustrative schematic illustration and does not signify a direct connection. The winding 3 is for example connected via the support element 5 to the base 11 for torque support.

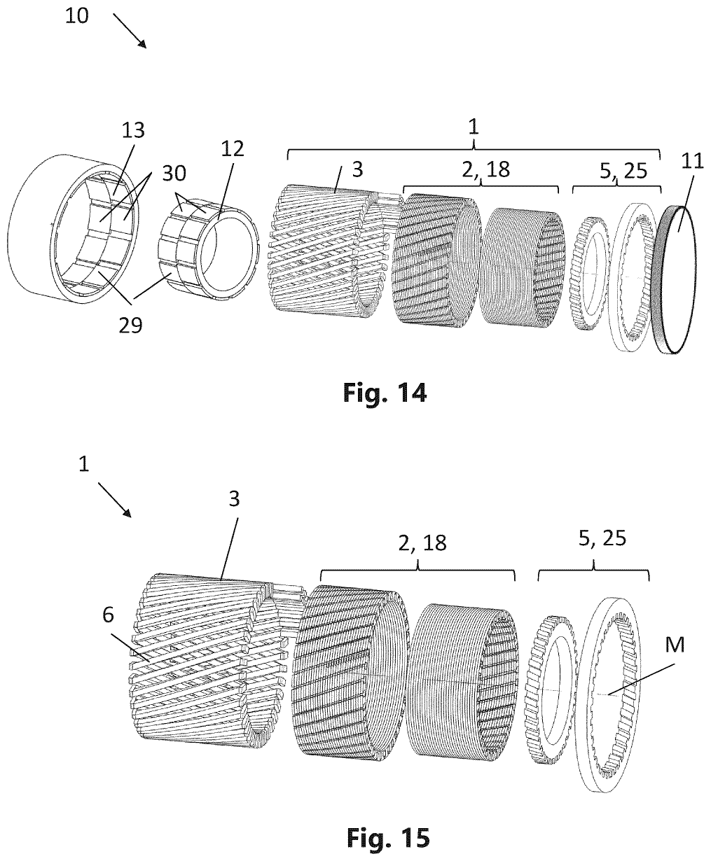

FIG. 14 shows an exploded view of a radial flux double-rotor machine 10 according to one embodiment.

The radial flux double-rotor machine 10 has, in addition to the components of the stator 1, a first rotor 12, second rotor 13 and a base 11. The first rotor 12 is arranged radially within the stator core 2 and the second rotor 12 is arranged radially outside the stator core 2. The rotors 12, 13 are manufactured for example from a soft-magnetic solid material and are fitted, on the respective surface facing the stator core, with permanent magnets, so-called surface magnets, as poles. The permanent magnets 29 are arranged as shown in FIGS. 1 and 2.

In this case, the base 11 is illustrated merely schematically for improved clarity. As already described in the description of FIG. 13, the base 11 is fastened in the mounted state to the support device 5. The base 11 is mechanically fixed with respect to a reference system, e.g. a support of a vehicle axle.

FIG. 15 shows an exploded view of a stator 1 according to one embodiment.

The stator 1 has a winding 3, a stator core 2 and a support device 5, wherein, in this case, an exemplary design of these components is illustrated more precisely in perspective.

The winding 3 is constructed from an inner and outer layer having a plurality of conductor bars 6 which are connected together in the manner of a bar structure. The conductor bars 6 in the inner and outer layers are arranged opposite one another in a helical manner and are coupled in an integrally bonded manner at the conductor bar ends to a radial conductor piece 17 connecting the inner and outer layer.

The thickness of the inner and outer layer corresponds in each case to the thickness of a conductor bar 6. That is to say that the winding 3 is formed in the manner of a respective conductor bar 6 by means of a single conductor layer which forms the conductor loop and has a comparatively large cross-section.

By reason of the bar structure formed with the conductor bars, the winding is torsionally stiff and is thereby self-supporting for torque support.

Accordingly, the conductor bars 6 form wave-shaped winding strands and can be interconnected by means of corresponding interconnections, which are known to a person skilled in the art and therefore are not described further, such as e.g. a delta connection, star connection or the like, to form a rotational field-generating winding having any number of strands.

In the illustrated embodiment, the stator core 2 and the support device 5 are each constructed from two components, by way of example. In order to assemble the stator 1, the winding 3, the stator core 2 and the support device 5 are arranged nested one inside the other. After assembly, the components are coaxially oriented with respect to one another on the common centre axis M. The support device 5 which, here by way of example, is in two parts is arranged axially offset with respect to the other components and forms the innermost and outermost component of the stator 1. This is an inner ring and an outer ring which are each designed having grooves for form-fitting engagement with the conductor bars.

The stator core 2 which, here by way of example, is in two parts is formed with two laminated stator cores 18, which are rotated with respect to one another in a helical manner, and this will be discussed further in detail with reference to FIG. 19.

In further embodiments, the stator core 2 and the support device 5 can each also be formed in one part or with more than two parts.

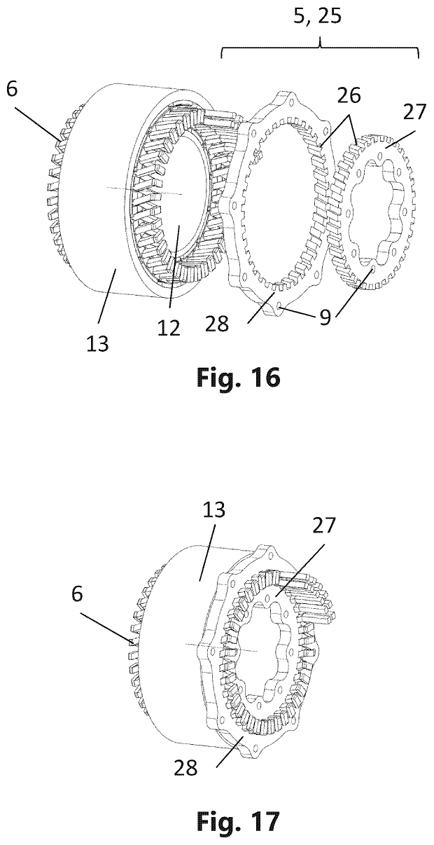

FIG. 16 shows an exploded view of a radial flux double-rotor machine 10 according to a further embodiment.

In this case, the radial flux double-rotor machine 10 has substantially identical components, as stated in relation to FIGS. 15 and 4. The stator core 2, the winding 3, the first rotor 12 and the second rotor 13 are illustrated in the assembled state on the left-hand side of the figure.

The support device 5 illustrated on the right is likewise formed in two parts and differs in terms of the configuration of the respectively annular inner support element 27 and outer support element 28. The support elements 27, 28 are equipped in this case with support grooves 26. They are provided on the inner periphery of the outer support element 28 and are provided on the outer periphery of the inner support element 27 for engagement with the conductor bars 6 of the winding 3.

To this end, the support grooves 26 are designed to be axially angled corresponding to the helical course of the conductor bars or the pitch thereof, so that they can be brought into engagement with the conductor bars 6 of the winding 3.

The support elements 27, 28 are produced for example from a conductive metal, for example from an aluminium alloy. The two-part design of the support elements 27, 28 renders it possible for the support grooves 26 to be easily accessible for mechanical or machining processing during production.

The inner support element 27 and the outer support element 28 are each provided circumferentially with a plurality of bores 9 for fastening to the base 11. In this case, the bores 9 are arranged by way of example along a hole circle distributed uniformly on the periphery. The individual bores 9 are located slightly outside the main body of the support elements and the support elements 27, 28 thus form a star shape on the periphery facing away from the winding in each case. Of course, other distributions of the bores 9 are feasible, as are other types of fastening means for the connection to the base 11.

FIG. 17 shows a perspective view of a radial flux double-rotor machine 10 as shown in FIG. 16 in the mounted state.

The support device 5 is fastened via the bores 9 e.g. in a machine housing (not illustrated) as a base 11 and thus carries the torque to the mechanically fixed part of the radial flux double-rotor machine 10. In this manner, the torque produced by the radial flux double-rotor machine 10 is supported effectively. The fastening of the support device 5 is effected via corresponding fastening means (not illustrated), e.g. screws.

The conductor bars 6 of the winding 3 extend axially on both sides to outside the stator core 2 and the first and second rotor 12, 13. The helically arranged conductor bars 6 of the radially inner and outer layer are connected together in each case outside the stator core 2.

In this case, the support elements 27, 28 are illustrated in engagement with the conductor bars 6 of the winding 3. It can be seen that a conductor bar 6 is placed in each support groove 26 so that all conductor bars are form-fittingly coupled to the support device. Therefore, a torque which is supported via the winding 3 can be supported via the support device 5 on the base 11 which is fastened to the bores 9.

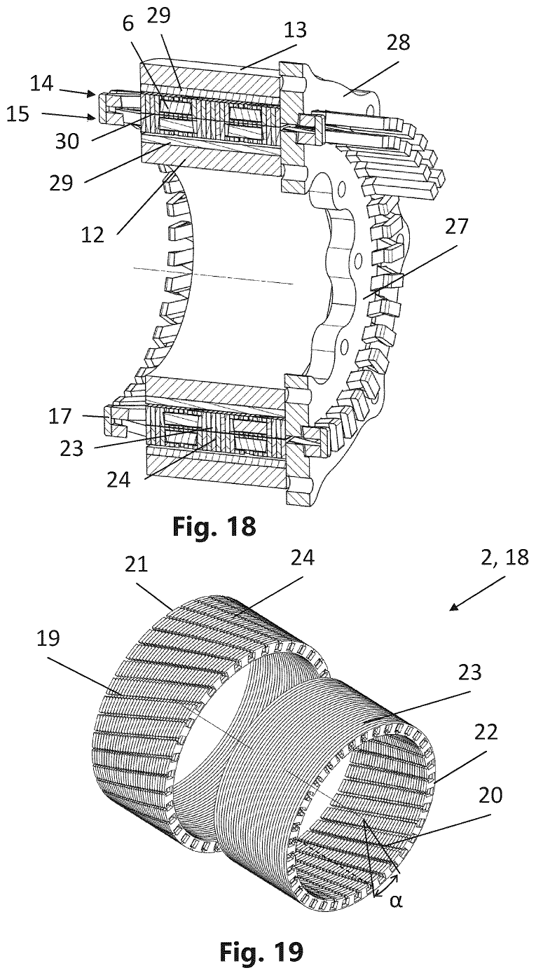

FIG. 18 shows a perspective longitudinal sectional view of a radial flux double-rotor machine 10 according to a still further embodiment.

This embodiment corresponds substantially to the assembly of a radial flux double-rotor machine 10 shown in FIG. 14, the components of which will be discussed further in detail hereinafter.

The stator core 2 has an inner partial package 23 and an outer partial package 24. The partial packages 23, 24 extend annularly between the first and second rotor 12, 13. The sectional view also makes it possible to see the inner and outer layers 14, 15 of the conductor bars 6 extending within the partial packages 23, 24.

The illustrated radial flux double-rotor machine 10 is a so-called “yokeless” design, in which the yoke does not lie between two teeth in functionally relevant magnetic flux. Therefore, although a stator yoke 38 extends between the conductor bars 6, it serves merely to hold the laminated stator core 18 mechanically together. A radial yoke thickness can be configured correspondingly thinly and, in the illustrated embodiment, amounts by way of example to approximately 10% of the entire radial stator thickness. In addition, with the comparatively small yoke thickness undesired magnetic leakage flux in the yoke is reduced. In further embodiments, the radial yoke thickness can be for this purpose less than 30%, for example less than 20%, for example less than 10% of the entire radial stator thickness.

The support device 5 also has an inner support element 27 and an outer support element 28. In this case, it can be clearly seen that the support elements 27, 28 are arranged axially offset with respect to the stator 5 and the rotors 12, 13. Furthermore, at least sections of the form-fitting engagement of the support elements 27, 28 with the conductor bars 6 of the inner and outer layers 14, 15 can be seen.

In this case, it can also be clearly seen that the conductor bars 6 of the inner and outer layers 14, 15 are connected at the conductor bar ends 16 via a radially arranged conductor bar piece 17. The connection is produced for example as an integrally bonded connection, e.g. by means of laser beam welding.

Furthermore, the surface magnets of the rotors 12, 13 can be seen in cross-section. The first rotor 12 has, on its outer peripheral surface, a plurality of permanent magnets. The second rotor 13 has, on its inner peripheral surface, a plurality of permanent magnets.

An exemplary embodiment is provided if the rotors consist of soft magnetic solid material and are produced having surface-mounted permanent magnets. In this design, the rotors can be manufactured very cost-effectively and a high degree of efficiency can be achieved.

FIG. 19 shows an exploded view of the laminated stator core 18 of the stator core 2.

The laminated stator core 18 of the stator core 2 has, as already mentioned, an inner partial package 23 and an outer partial package 24. This serves to simplify the production of the stator grooves 19, which are rotated in opposite directions with respect to one another, with the same inner and outer stator sheets 21, 22 which are stacked in a rotated manner with respect to one another and are provided with recesses at the same locations.

In further embodiments, the stator sheets can also be formed in one part, so that a multiplicity of differently formed stator sheets are provided having differently arranged recesses and are stacked in the sequence necessary for forming the stator grooves. In yet further embodiments, it is also feasible to have completely one-part stator cores 2 which can be manufactured e.g. additively.

In the illustrated two-part design, an inner diameter of the outer partial package 24 is almost equal to the outer diameter of the inner partial package 23. This renders it possible to arrange the inner partial package 23 coaxially within the outer partial package 24.

The partial packages 23, 24 are constructed from individual annular stator sheets 21, 22 which are stacked one on top of the other. The stator sheets 21 of the outer partial package 24 are manufactured with recesses, which are positioned distributed on the outer periphery, in order to form the outer stator grooves 19. The stator sheets 22 of the inner partial package 23 are manufactured with recesses, which are positioned distributed on the inner periphery, in order to form the inner stator grooves 20. For example, manufacture of such stator sheets by punching is advantageous by reason of the edge quality and very low production costs.

The inner and outer stator grooves 19, 20 describe helical lines which extend oppositely with respect to one another with the same pitch and are characterised by the indicated swept angle of the stator grooves a. The swept angle of the stator grooves a can be defined from the angle between the position of the same stator groove on one axial side of the stator core 2 and on the other axial side of the stator core 2 in relation to the centre axis M.

In this case, the stator grooves 19, 20 are designed by way of example as T-grooves having a rectangular recess with a tapered opening. They are provided in particular for receiving conductor bars having a rectangular cross-section in a form-fitting manner. Of course, the geometry of the recesses or stator grooves can be adapted to the conductor geometry. Other cross-sectional shapes would also be feasible for this purpose.

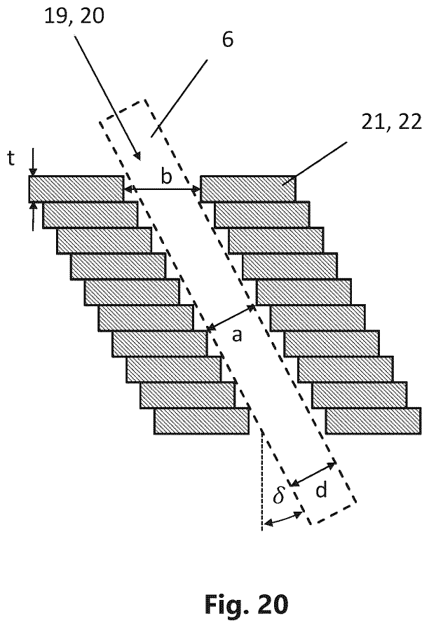

FIG. 20 shows a schematic longitudinal sectional view of a stator groove 19, 20.

The usable or continuous clear width a of the stator grooves 19, 20 within the laminated stator core 18 is substantially equal to the width of the conductor bars 6 received within the stator core 2.

The stator sheets 21, 22 have straight, in particular punched, edges. By reason of the offset of the sheets with respect to one another, a width b of the recesses provided for the stator grooves 19, 20 is larger than the width d of the conductor bars 6 by an amount which is predetermined by the pitch 8 of the helical shape of the course and the sheet thickness t.

In FIG. 20, a conductor bar 6 is schematically indicated with dashed lines in the stator groove 19, 20, wherein, in order to provide a clearance fit, the continuous clear width a of the stator groove 19, 20 is slightly larger than the width d of the conductor bar 6 and the width a of the recess in the stator sheet 21, 22 is, in turn, considerably larger than the clear width b.

The sheet thickness t and the setting angle 8 of the pitch of the groove course represent a noticeable influencing factor for the difference between the width b of the recess and the clear width a of the usable passage within the groove in the case of straight, e.g. punched, sheet edges. The difference comes about because the pitch angle on the one hand and the staircase-like stepped configuration of the laminated core on the other hand are to be compensated for.

In this case, a minimum size of the width a of the recess for the limit case of infinitely thin sheets, i.e. a pure consideration of the pitch angle δ of the conductor bar, would be

b=1/cos(δ)*d.

In order, on the one hand, to compensate for the actual sheet thickness and, on the other hand, to provide a clearance fit which allows the insertion of the conductor bars, the width b of the recess is actually provided to be even larger.

The width b of the recesses shown in FIG. 20 is dimensioned in such a way that a clear width a of the stator grooves 19, 20, which is reduced by the offset between the recesses of the stator sheets, forms a predetermined clearance fit with the width d of a conductor bar 6 to be introduced into the stator groove, but the contact is nevertheless close enough to serve for uniformly distributed power transmission or torque support between the laminated stator core and the winding. Such dimensioning is made possible, inter alia, by virtue of the fact that, on the one hand, each stator sheet is formed identically with a high edge quality and is rotated with the same offset, and, on the other hand, only an individual conductor bar 6 is placed in each stator groove 19, 20, the dimensions of said conductor bar being constant.

In particular, in the illustrated embodiment the conductor bar 6 is a rectangular bar having an edge length or width of several millimetres, e.g. in the range of 2 mm to 6 mm, in particular in the range of 3 mm to 5 mm. for example, this can be a rectangular profile of 5 mm×3 mm.

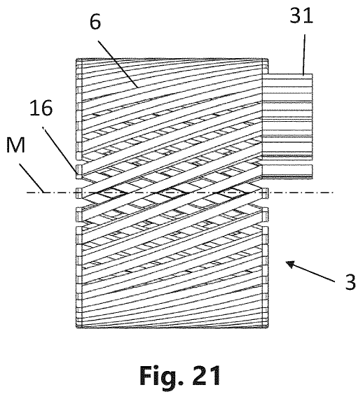

FIG. 21 shows a plan view of a winding 3.

In this view, it is clear to see the exactly radial orientation of the conductor bars at each point of the helical course thereof which, in the illustrated perspective, is aligned in the region of the centre axis M. The conductor bar ends 16 form in each case the connection point between the inner and outer radial layer 14, 15.

In the illustrated embodiment, the winding has by way of example a total of twelve connection contacts 31. In the case of a three-strand interconnection, a three- phase operation is for example provided. However, the winding can be adapted in a manner known to a person skilled in the art to other interconnections to form a rotational field-generating winding with any number of strands.

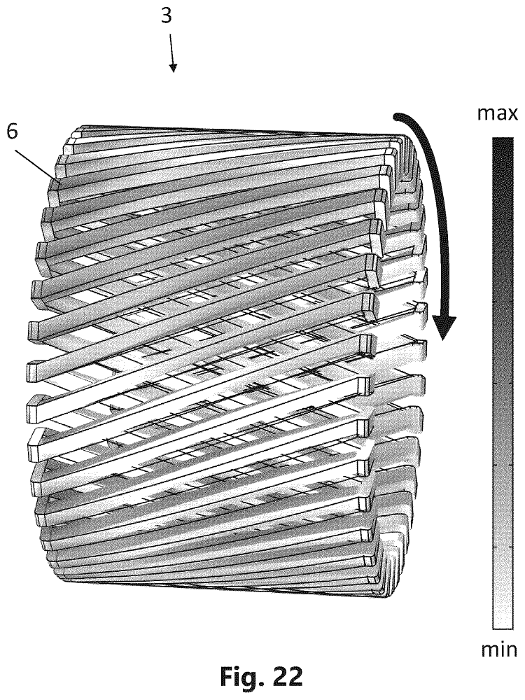

FIG. 22 shows a perspective view of an FEM simulation of a winding 3 under load.

With minor simplifications for simulation purposes, this is for example the winding geometry illustrated in FIG. 7. The scale illustrated relates to the stresses within the winding, wherein, by way of example, in the case of a rectangular profile of the conductor bars 6 of 5 mm×3 mm, this can be a scale of 0 MPa to 30 MPa.

In this example, the conductor bar ends are defined by means of a swept angle of the conductor bars β>0, i.e. helically arranged and formed or formed in a correspondingly twisted manner. At the axial end, on which the support device engages, a maximum torque of the correspondingly dimensioned radial flux double-rotor machine 10, as indicated by a thick arrow, is plotted, wherein, by way of example, in the case of a rectangular profile of the conductor bars 6 of 5 mm×3 mm, this can be about 5000 Nm.

It is evident that the stresses within the winding are distributed very homogeneously by reason of the helical line geometry. In spite of the set significant exaggeration, a deformation can scarcely be seen. Therefore, by reason of this design stress peaks and thus also the deformation are considerably reduced.

By reason of the bar structure-like construction, a high torque can thus be absorbed by the winding 3 in a self-supporting manner when fixing an axially accessible winding end, without causing unacceptably large deformations and/or stress states. This can be attributed in particular to the fact that in the bar structure, the conductor bars 6 predominantly absorb tensile and compressive stresses when subjected to tangential force.

When compared to designs with axis-parallel, straight conductors, the mechanical stresses can thus be significantly reduced.

FIG. 23 shows a perspective view of a comparative model with a straight design and axial progression of the conductor bars 6 under load.

In comparison with FIG. 22, by reason of the straight design and the axial progression of the conductor bars, a stress course concentrated on the side illustrated in FIG. 22 on the left and a strong deformation of the conductor bars resulting from the locally high stress with a large deflection on the side illustrated in FIG. 23 on the right can be seen. Here, the same stress scale and the same exaggeration in deformation are set as in FIG. 22, which shows the effect of the different structural arrangements on the torsion stiffness.

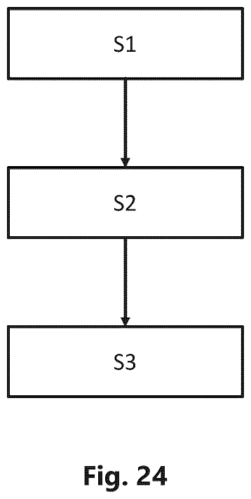

FIG. 24 shows a flow diagram of a method for producing a stator 1.

The method comprises a first step of providing S1 a stator core 2 having radially outer stator grooves 19 each describing a helical line and radially inner stator grooves 20 each describing a helical line with an opposite turning direction. A further step concerns introducing S2 individual conductor bars 6 following the helical lines through the inner and outer stator grooves 19, 20. The conductor bars are introduced in particular in an axial direction. Furthermore, a step is provided of connecting S3 the conductor bars 6, which are introduced into the inner and outer stator grooves, on the conductor bar ends 16 in order to form conductor loops.

Although the present invention has been described in full above with the aid of some exemplified embodiments, it is not limited thereto but can be modified in diverse ways.

1. A radial flux double-rotor machine,
comprising a stator which has a stator core and a torsionally stiff winding received therein, wherein in a radially inner part of the stator the conductor bars of the torsionally stiff winding extend helically in a first direction of rotation, and in a radially outer part of the stator the conductor bars of the torsionally stiff winding extend helically in an opposite second direction of rotation;
comprising a double rotor which has an inner rotor and an outer rotor, wherein the inner rotor and the outer rotor each have an annular main body which is designed for carrying flux, and a common centre axis,
wherein a plurality of permanent magnets are fastened in each case to the annular main body and each permanent magnet is allocated in the cross-section a predetermined angle segment of the annular main body,
wherein the permanent magnets are formed and arranged on the respective annular main body such that the predetermined angle segment is displaced in the axial progression in the circumferential direction so that the permanent magnets generate a field which extends obliquely with respect to the centre axis, wherein a field of the inner rotor extends obliquely in a first direction which is oriented to the first direction of rotation, and wherein a field of the outer rotor extends obliquely in a second direction which is oriented to the second direction of rotation.

2. The radial flux double-rotor machine of claim 1,
wherein the annular main body is manufactured from solid material.

3. The radial flux double-rotor machine of claim 1,
wherein the permanent magnets are arranged at a predetermined helix angle relative to the axial direction of the centre axis on the annular main body.

4. The radial flux double-rotor machine of claim 1,
wherein the permanent magnets are each divided into a plurality of axial segments, wherein each axial segment is allocated an angle segment which is displaced with respect to an adjacent axial segment by a setting angle about the centre axis, wherein a resulting total helix angle in the circumferential direction is determined from the setting angle.

5. The radial flux double-rotor machine of claim 4,
wherein in the case of a predetermined number of n axial segments per permanent magnet, the resulting total helix angle ϕ in the circumferential direction is determined from the setting angle θ with the relation, ϕ=n*θ.

6. The radial flux double-rotor machine of claim 4,
wherein the permanent magnets are each divided into two axial segments.

7. The radial flux double-rotor machine of claim 3,
wherein the permanent magnets are oriented with an edge along the predetermined helix angle.

8. The radial flux double-rotor machine of claim 7,
wherein the permanent magnets have an oblique parallelogram shape.

9. The radial flux double-rotor machine of claim 1,
wherein the winding has, in the radially inner part of the stator, a radially inner layer of helically arranged conductor bars and has, in the radially outer part of the stator, a radially outer layer of oppositely helically arranged conductor bars.

10. The radial flux double-rotor machine of claim 1,
wherein the stator core contains a laminated stator core with stator grooves extending helically corresponding to the winding course, wherein inner stator grooves of the radially inner part of the stator extend according to the first direction of rotation and outer stator grooves of the radially outer part of the stator extend according to the second direction of rotation oppositely with respect to one another.

11. The radial flux double-rotor machine of claim 10,
wherein the laminated stator core contains an inner partial package with radially inner stator grooves and an outer partial package with radially outer stator grooves, wherein the stator sheets of the inner partial package are designed having an identical geometry in each case and the stator sheets of the outer partial package are designed having an identical geometry in each case, and wherein the stator sheets of the inner partial package according to the first direction of rotation of the conductor bars and the stator sheets of the outer partial package according to the second direction of rotation of the conductor bars are stacked in a manner twisted oppositely with respect to one another by a predetermined angle of twist about the centre axis.

12. The radial flux double-rotor machine of claim 11,
wherein the resulting total helix angle in the circumferential direction of the permanent magnets of the inner rotor is in a range of 20% to 40% of the angle of twist of the stator sheets of the inner partial package or
wherein the resulting total helix angle in the circumferential direction of the permanent magnets of the outer rotor is in a range of 20% to 40% of the angle of twist of the stator sheets of the outer partial package.

13. The radial flux double-rotor machine of claim 1,
wherein the permanent magnets of the inner rotor and the outer rotor have a predetermined tangential width,
wherein the stator core has a radial yoke thickness which is in the range of 5% to 25% of a tangential pole width.

14. The radial flux double-rotor machine of claim 1, wherein the radial flux double-rotor machine is configured for a wheel hub drive.

15. The radial flux double-rotor machine of claim 5,
wherein the permanent magnets are each divided into two axial segments.

16. The radial flux double-rotor machine of claim 11,
wherein the resulting total helix angle in the circumferential direction of the permanent magnets of the inner rotor is in a range of 25% to 35% of the angle of twist of the stator sheets of the inner partial package, or
wherein the resulting total helix angle in the circumferential direction of the permanent magnets of the outer rotor is in a range of 25% to 35% of the angle of twist of the stator sheets of the outer partial package.

17. The radial flux double-rotor machine of claim 11,
wherein the resulting total helix angle in the circumferential direction of the permanent magnets of the inner rotor is in a range of 28% to 32% of the angle of twist of the stator sheets of the inner partial package, or
wherein the resulting total helix angle in the circumferential direction of the permanent magnets of the outer rotor is in a range of 28% to 32% of the angle of twist of the stator sheets of the outer partial package.

18. The radial flux double-rotor machine of claim 11,
wherein the resulting total helix angle in the circumferential direction of the permanent magnets of the inner rotor is in a range of 20% to 40% of the angle of twist of the stator sheets of the inner partial package, and
the resulting total helix angle in the circumferential direction of the permanent magnets of the outer rotor is in a range of 20% to 40% of the angle of twist of the stator sheets of the outer partial package.

19. The radial flux double-rotor machine of claim 11,
the resulting total helix angle in the circumferential direction of the permanent magnets of the inner rotor is in a range of 25% to 35% of the angle of twist of the stator sheets of the inner partial package. and
the resulting total helix angle in the circumferential direction of the permanent magnets of the outer rotor is in a range of 25% to 35% of the angle of twist of the stator sheets of the outer partial package.

20. The radial flux double-rotor machine of claim 11,
the resulting total helix angle in the circumferential direction of the permanent magnets of the inner rotor is in a range of 28% to 32% of the angle of twist of the stator sheets of the inner partial package, and
the resulting total helix angle in the circumferential direction of the permanent magnets of the outer rotor is in a range of 28% to 32% of the angle of twist of the stator sheets of the outer partial package.

21. The radial flux double-rotor machine of claim 1,
wherein the permanent magnets of the inner rotor and the outer rotor have a predetermined tangential width,
wherein the stator core has a radial yoke thickness which is in the range of 10% to 20% of a tangential pole width.

22. The radial flux double-rotor machine of claim 1,
wherein the permanent magnets of the inner rotor and the outer rotor have a predetermined tangential width,
wherein the stator core has a radial yoke thickness which is in the range of 12.5% to 17.5% of a tangential pole width.
